(19) United States
(12) Patent Application Publication
(10) Pub. No.: US 2015/0274317 A1
(43) Pub. Date: Oct. 1, 2015

(54) SAFETY ARRANGEMENT FOR AIRCRAFT AND METHOD FOR DETERMINING TYPE OF THE LANDING SURFACE FOR AN AIRCRAFT

(71) Applicant: Suokas Avionics Oy, Lahti (FI)

(72) Inventor: Aki SUOKAS, Lahti (FI)

(21) Appl. No.: 14/673,290

(22) Filed: Mar. 30, 2015

(30) Foreign Application Priority Data
Mar. 31, 2014 (FI) 20145308

(51) Int. Cl. B64D 45/04; B64D 45/00

(52) U.S. Cl. CPC B64D 45/04; B64D 45/0005

(57) ABSTRACT

A safety arrangement (300, 310, 320, 330, 340) for an aircraft, especially for amphibious aircraft, being configured for determining a type of landing surface (such as water/solid ground) and including: a first transceiver (301) configured to operate on electromagnetic wavelength, a second transceiver (302) configured to operate on ultrasound wavelengths, and determining elements for determining the type of the landing surface based on the properties of reflections of the electromagnetic and ultrasound wavelengths, and for outputting a signal indicating the type of the determined landing surface.

### TECHNICAL FIELD OF THE INVENTION

The invention relates to a safety arrangements for an aircraft and a method for determining the type of the landing surface for an aircraft. Especially the invention relates to amphibious aircraft.

### BACKGROUND OF THE INVENTION

Aircrafts require a landing gear for landing and taking-off. Term aircraft relates to all kinds of fixed-wing and rotary-wing aircraft. Airplanes are fixed-wing aircrafts that conventionally land on and take-off on runways. Land airplanes (operate on land or solid ground) comprise fixed or retractable landing gear. The retractable landing gear is retracted inside the fuselage to reduce an aerodynamic drag after the take-off or during the flight. (However fixed landing gear is not retractable.) The retractable landing gear must be deployed or in landing position when landing on the runway.

A seaplane is a powered fixed-wing aircraft capable of taking off and landing (alighting) on water. Seaplanes are either flying boats or floatplanes. In a flying boat, the main source of buoyancy is the fuselage, which acts like a ship's hull in the water because the fuselage's underside has been hydrodynamically shaped to allow water to flow around it. A floatplane has slender pontoons, or floats, mounted under the fuselage. Two floats are common, but other configurations are possible. Only the floats of a floatplane normally come into contact with water. The fuselage remains above water.

However, there are also amphibious airplanes and they can operate on ground (runways) or water. Amphibious airplanes comprise a conventional wheeled type landing gear for landing on ground and pontoon structures or “floats” for water landing. For landing on runways or ground, the conventional landing gear must be in landing position or landing configuration so that it is extended below the airplanes pontoon structures. And for landing on water, this landing gear must be retracted, so that landing on water happens with pontoons/floats. In such case landing gear is typically retracted inside the fuselage, wings or pontoons. Thereby amphibious airplanes have two configurations for landing gear depending on the landing surface type.

When amphibian (amphibious aircraft) lands on ground with landing wheels retracted, the plane will make contact with the runway with pontoons. This causes some damage to the parts of the plane and to the pilot's self-esteem. Usually the damages are minor in such case.

On the other hand, when the amphibian is landing on water and the landing gear is extended, the aircraft will typically flip forward into the water upon the landing gear's contact with the water. This causes damage to the aircraft and injury to the crew and passengers. The damages to the amphibian in such event are usually severe: The plane will decelerate and stop within very short distance, flip over on its back into the water. Damages are caused by the rapid deceleration, water entering electronic equipment and engine while it is running. Such damages can result in scrapping the plane completely.

One of the biggest causes for accidents and the largest source of insurance claims for amphibious aircraft are related to the improper landing gear configuration when landing on a certain type landing surface. Amphibian pilots are particularly susceptible to committing gear status errors due to the difference in the proper gear status for any landing surface; any pilot can make such a mistake.

Therefore, amphibians nowadays comprise different type warning systems to help the pilot to take care of proper landing gear configuration when landing an amphibious aircraft.

From the prior art is known U.S. Pat. No. 4,516,124, which discloses an advisory system for the pilot of an amphibious aircraft with retractable landing gear for checking the status of the landing gear. The apparatus senses changes in aircraft speed indicative of an imminent landing and prompts the pilot to verify that the landing gear is in a position compatible with the type of surface, land or water, chosen for landing.

From the prior art is also known US2006226286, which discloses system for controlling landing gear of an aircraft. The system comprises a sensor for sensing water, and the sensor is coupled to the landing gear to retract so as to retract the landing gear when the sensor senses a body of water. The system operates during the contact of landing and operates as kind of anti-flip system.

From the prior art is also known US2003011493, which discloses an aircraft landing gear warning apparatus. The apparatus comprises a computer operatively connected to a surface monitor and a gear-status warning indicator. Preferably the surface monitor is a laser distance measuring system. However any sensing subsystem which is capable of determining the altitude of the aircraft is suitable, although preferably the sensing subsystem also indicates the landing surface (e.g., ground or water). The computer also accepts an input from the gear status sensors to determine if the landing gear is extended or retracted. If the system senses a water surface and the landing gear is down, a warning alerts the pilot that the landing gear is in the incorrect configuration.

In an embodiment of US2003011493, the surface monitor is comprised of two laser distance-measuring systems. A first laser distance measuring system is used to emit a narrow laser beam, which provides a good return when reflected off of land. A second laser distance measuring system is used to emit a spread laser beam, which provides a good return when reflected off of water. In operation both the first and second laser distance measuring systems would emit laser beams continuously.

There are however some disadvantages relating to the known prior art, such as still occurring accidents caused by improper landing gear configuration when landing, despite of the presence of warning or advisory systems. A major portion of amphibious aircraft landing accidents is caused by improper landing gear configuration/position during landing.

The drawback of advisory systems, like U.S. Pat. No. 4,516,124, is that they operate every time plane is landing or about to land and require pilot input for selecting the landing surface type. This causes that the pilot has to manually operate the system every time, which creates an autonomic reactions to silence the system without consciously making the selections for the respective landing surface type.

Another drawback for anti-flip systems for preventing the flipping the amphibian, is that these systems operate at the moment of the contact with landing surface. This means that pilot error has already occurred. In such case the outcome depends on the operation and reliability of the anti-flip system.

Yet another drawback relates to warning systems that are comprised of two laser-distance measuring systems, of which first one emits narrow laser beam and second one emits spread laser beam. These systems may give erroneous warnings when there is water on runway or when landing on shallow water and bottom reflects a confusing signal. Furthermore, these systems are susceptible for dirt or other problems that cause weakening of the signal or the measurement.

### SUMMARY OF THE INVENTION

An object of the invention is to alleviate and eliminate the drawbacks relating to the known prior art. Especially the object of the invention is to provide an improved safety arrangement for an aircraft. Another object of the invention is to provide improved and reliable method for determining type of the landing surface for an aircraft.

The object of the invention can be achieved by the features of independent claims. The invention relates to a safety arrangement according to claim 1. In addition the invention relates to a method for determining a type of the landing surface for an aircraft according to claim 11, an aircraft, such as an amphibious aircraft according to claim 17, and a computer program product for determining a type of the landing surface for an aircraft according to claim 18.

The following presents a simplified summary in order to provide a basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

According to an embodiment of the invention, a safety arrangement for an aircraft is configured for detecting a type of landing surface (such as water or solid ground, e.g. suitable for runway). Advantageously the safety arrangement is for amphibious aircraft.

The safety arrangement comprises

a first transceiver configured to operate on electromagnetic wavelength, where said transceiver is configured to transmit said electromagnetic wavelength essentially towards said landing surface and to receive the reflections of said electromagnetic wavelengths,

a second transceiver configured to operate on ultrasound wavelengths, where second transceiver is configured to transmit said ultrasound wavelengths essentially towards said landing surface and to receive the reflections of said ultrasound wavelengths.

The transceivers are configured to transmit or emit the said (electromagnetic and ultrasound) wavelength essentially towards said landing surface (essentially downwards or towards landing area, when said aircraft is essentially in normal flying state or position) and to receive the reflections of said wavelengths. Advantageously, one of the transceivers is configured to receive (detect and measure) the reflections of all electromagnetic wavelengths, which were transmitted. It is also possible that all transceivers are configured to receive their own transmitting wavelengths. Advantageously, every transceiver is configured to receive the reflections of all transmitted electromagnetic wavelengths, in order to obtain more accurate detection and/or enhance the operation or reliability of the safety arrangement.

The meaning of transmit a wavelength (electromagnetic or ultrasound) refers to that said transceiver(s) transmit on that wavelength, and transmitted can also be referred to as a signal. Basically transceivers are configured to transmit on designated wavelength, and so it can be referred later on either as a signal or as a wavelength.

The safety arrangement comprises also determining means (implemented e.g. by suitable software or data processing unit/means) for determining the type of the landing surface based on the properties of said reflections of said electromagnetic and ultrasound wavelengths when reflected from said landing surface, and for outputting a signal indicating the type of the determined landing surface.

The safety arrangement may comprise also one or more additional transceivers which operate or transmit on their own separate wavelength. Thereby, these additional transceivers transmit a signal on their own, separate electromagnetic wavelengths.

If the safety arrangement comprises more than two transceivers, the safety arrangement may advantageously determine the type of the landing surface based on the properties of received reflections of transmitted wavelengths.

The safety arrangement thereby determines the landing surface type based on determining the properties of the reflected signals. The properties of the received signal depend on when it is reflected from the landing surface. Also, the time to receive the reflection is one essential property, and depends on the distance of reflecting surface, e.g. landing surface. The properties of reflected electromagnetic signal change differently depending on the type of the landing surface (usually reflecting surface), namely ground (runway) or water. The reflecting surface usually corresponds to the landing surface; however this is not always the case. When the both reflections are received from landing surface this is also reflecting surface. However, in some cases, reflecting surface for one wavelength may be different than for the other. In such case one reflecting surface does not necessarily correspond to landing surface.

Furthermore, the properties of reflected electromagnetic signal also depend on the wavelength. These properties of the transmitted electromagnetic wavelength comprise at least:

distance=distance from reflecting surface determined by time to receive the reflection

intensity of the reflection/absorption of the reflecting surface

intensity variations in the received wavelength

polarization: whether the reflection polarization corresponds with solid ground of water.

Time to receive the reflection of the transmitted wavelengths is related to the distance of a reflecting surface. The reflecting surface usually corresponds to the landing surface, namely ground or water. However, the reflecting surface may be different for electromagnetic and ultrasound wavelengths. This is because ultrasound is reflected better from surface of water than that of electromagnetic signal. And vice versa the electromagnetic signals are reflected better from vegetation (trees, bushes, plants) than that of ultrasound signals.

Intensity of the reflection depends mainly on the absorption of the electromagnetic or ultrasound wavelengths transmitted by the transceivers. However, also the distance has effect on the reflection intensity, because signals dissipate over certain distance, especially for ultrasound. Also the quality of the reflecting surface (roughness, irregularities, angle) effects on the reflection intensity.

Intensity variations of the reflected wavelengths may be caused by several reasons. A fluctuation in the intensity of the reflected signal is usually due to surface waves when reflected from the surface of water.

Polarization of the electromagnetic reflection depends on the properties of the reflecting surface. Polarization is different depending on whether the signal is reflected from the solid surface or surface of water. The surface type can be determined to runway if polarization property of reflection corresponds with solid ground, and on the other hand, the surface type can be determined to water if polarization property of reflection corresponds with water. The polarization properties are predetermined for respective types of landing surface beforehand.

After determining the type of the landing surface based on the properties of said reflections of the wavelengths, the determining means outputs a signal indicating the type of the determined landing surface. The outputted signal distinguishes whether the landing surface is ground or water. The outputted signal may be electrical signal, or signal may be in form of a sound, light, or vibration.

According to an embodiment of the invention the safety arrangement comprises detecting means for detecting position of a landing gear. In such case the safety arrangement detects the position, or configuration, of a landing gear.

According to an embodiment of the invention, the safety arrangement comprises determining means for determining whether landing gear is in correct or incorrect position in relation to the respective type of landing surface. In such case the safety arrangement determines whether landing surface is ground or water and detects configuration of the landing gear (whether it is in or out) and determines whether the landing gear is in correct position for the type of the landing surface. When landing on ground or runway, the landing gear should be out (extended) and when landing on water, the landing gear should be retracted.

According to an embodiment of the invention the safety arrangement comprises controller for outputting signal, such as sound, light, and/or tactile/vibration effect, indicating the type of the determined landing surface and/or whether the landing gear is in correct or incorrect position corresponding the type of the landing surface based on the determined type of the landing surface and the position of the landing gear. Advantageously, the safety arrangement provides a signal when landing gear configuration is in improper/incorrect position. Advantageously the signal may be an automatic signal to automatic controllers. Also advantageously the signal may be a signal for the pilot.

According to an embodiment of the invention the safety arrangement comprises a detecting means for detecting that landing is iniated based on by detecting a predetermined value of at least one of the following: flaps in landing position, engine power level, and/or velocity, and/or velocity transition from a cruising speed to a landing speed, altitude, descending speed (variometer). Advantageously, the safety arrangement activates itself when detecting that landing is iniated based on as said above.

According to an embodiment of the invention the first transceiver operates on electromagnetic wavelength in the range of 400-2200 nm, preferably in the range of 400-700 nm.

The transceiver operating on ultrasound wavelengths, the ultrasound range lower limit is 20 kHz. Operationally there is no upper limit except the technical implementation.

According to an embodiment of the invention the safety arrangement comprises third transceiver configured to operate on wavelength in the range of 380-500 nm.

According to an embodiment of the invention the safety arrangement determines the surface type by comparing the distance measurements between the said two different wavelengths.

According to an embodiment of the invention the safety arrangement determines the surface type based on the absorption of the two different wavelengths by the reflecting surface.

According to an embodiment of the invention, a method for determining a type of the landing surface for an aircraft, especially for amphibious aircraft, comprises the steps:

transmitting in an electromagnetic wavelength and in an ultrasound wavelength essentially towards said landing surface,

receiving the reflections of said electromagnetic and ultrasound wavelengths

determining the properties of said two wavelengths reflected from said landing surface,

determining the type of the landing surface based on the properties of said two wavelengths reflected from said landing surface

According to an embodiment of the invention, the method comprises a step of detecting the position of a landing gear and determining whether the landing gear is in correct or incorrect position corresponding the type of landing surface.

According to an embodiment of the invention, the method comprises a step of outputting a signal, such as sound, light, and/or tactile/vibration effect, which indicates whether the landing gear is in correct or incorrect position corresponding the type of the landing surface based on the determined type of the landing surface and the position of the landing gear.

According to an embodiment of the invention, the method comprises a step of determining the surface type by comparing:

the distance measurements between the said two different wavelengths and/or

the absorption between the two different wavelengths by the reflecting surface.

According to an embodiment of the invention an aircraft, such as an amphibious aircraft, comprises the said safety arrangement.

An embodiment of the invention is a computer program product for determining a type of the landing surface for an aircraft, which comprises program code means that are stored on a computer-readable medium, and which code means are arranged to perform the steps of the method according to any embodiment of the invention, when the program is run on a computer.

An embodiment of the invention is that the safety arrangement comprises a warning means if the safety arrangement is not working properly.

The present invention, and its embodiments, offer advantages over the known prior art, such as enhanced reliability of the determining the type of the landing surface, and more simple structure of the safety arrangement. For example, one advantage is that the invention is not as sensitive to dirt on the transceivers as prior art, because of similar effect of the dirt on both transceivers and thereby the transceivers maintaining equal relative intensities and because of utilizing different wavelengths. The enhanced reliability yields from utilizing at least two different types of wavelengths or signals, electromagnetic and ultrasound. The present invention, and its embodiments, offer also improved safety for operating amphibious aircraft and for landing on different types of landing surfaces.

The exemplary embodiments of the invention presented in this patent application are not to be interpreted to pose limitations to the applicability of the appended claims. The verb “to comprise” is used in this patent application as an open limitation that does not exclude the existence of also unrecited features. The features recited in depending claims are mutually freely combinable unless otherwise explicitly stated.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

Next the invention will be described in greater detail with reference to exemplary embodiments.

FIG. 1 illustrates an absorption spectrum of electromagnetic radiation for liquid water (Source: http://en.wikipedia.org/wiki/File:Absorption_spectrum_of_liquid_water.png, retrieved 15.01.2014)

FIG. 2 illustrates a reflectance spectrum of soil (=ground), water, and vegetation for comparison. Source: Siegmund, Menz 2005 with modifications, (Retrieved 15.01.2014: http://www.seos-project.eu/modules/remotesensing/remotesensing-c01-p05.html)

FIGS. 3A-3D illustrate a principle of an exemplary arrangement and method for determining a surface type according to an advantageous embodiment of the invention.

### DETAILED DESCRIPTION

One example of one embodiment of the present invention is a safety arrangement for an amphibious aircraft, which safety arrangement is configured for detecting the type of a landing surface.

The safety arrangement comprises two transceivers, and the first transceiver is configured to operate (or transmit and receive) on electromagnetic wavelength and the second transceiver is configured to operate (or transmit and receive) on ultrasound wavelength.

The transceivers are configured to transmit essentially towards said landing surface (meaning essentially downwards or towards landing area, when said aircraft is essentially in normal flying state or position) and configured to receive the reflections of said transmitted wavelengths.

The safety arrangement comprises determining means for determining the type of the landing surface based on the properties of reflections of said wavelengths when reflected from said landing surface, and for outputting a signal indicating the type of the determined landing surface.

Advantageously the safety arrangement determines whether the landing surface is solid surface (ground/runway) or water.

The outputted signal may be electric, sound, light, or vibration signal. Advantageously, in case of the electrical signal, it is connected to other systems.

The operation of the safety arrangement is based on that electromagnetic and ultrasound wavelengths are reflected differently from a certain type of landing surface. Therefore, the type of the landing surface can be distinguished from another type by determining the properties of reflection of the transmitted wavelengths.

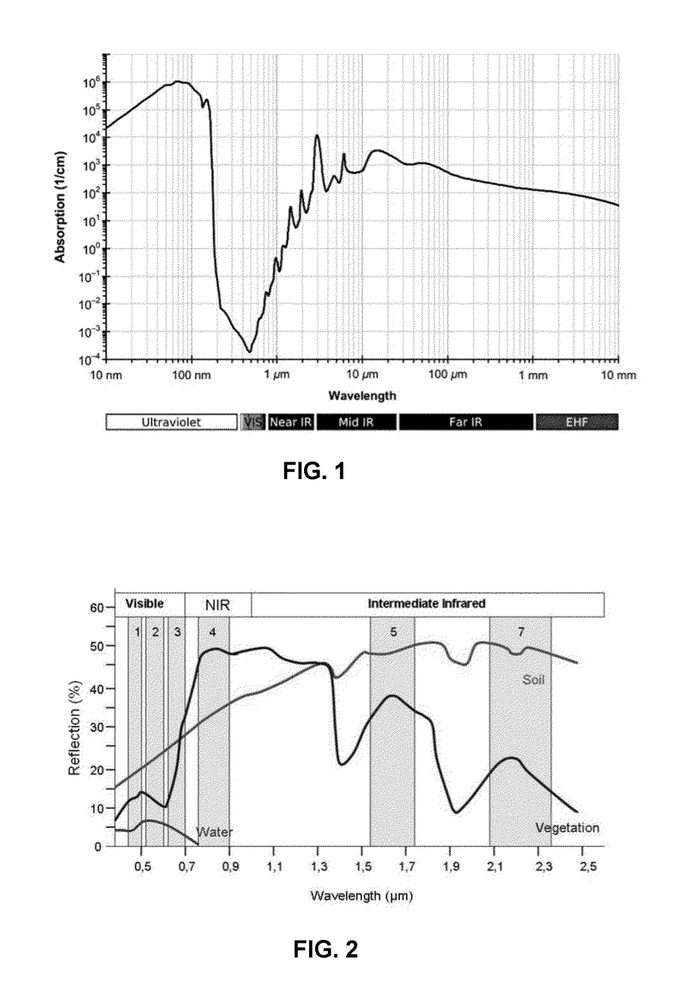

FIG. 1 illustrates an absorption curve of electromagnetic wavelengths for liquid water. In FIG. 1 is illustrated that visible light has relatively small absorption in the water. However infrared wavelengths have significantly bigger absorption in the water. When absorption is bigger, the reflection is weaker. The reflection from the water for infrared wavelengths is very weak, but for visible light relatively stronger when compared to infrared wavelengths.

Based on the properties of reflections of two different wavelengths, electromagnetic and ultrasound, it is possible to determine the type of the landing surface. The properties of the reflection in determining the type of the landing surface is at least one of the following:

distance: distance from reflecting surface determined by time to receive the reflection

intensity of the reflection/absorption of the reflecting surface

intensity variations in the received wavelength

polarization: whether the reflection polarization corresponds with solid ground of water

The present invention utilizes on one part for example the different absorption or reflections of electromagnetic and ultrasound wavelengths in landing surface: The electromagnetic wavelength is selected from infrared range of electromagnetic wavelengths (near IR, mid IR, far IR), preferably in the range of between 400-2200 nm. The second transceiver operates on ultrasound wavelength, preferably over 20 kHz. The difference between the intensity of the reflections indicates reliably the type of the landing surface, specifically whether the surface below is water or solid ground (=runway).

The determination is based partially on the difference how ultrasound and electromagnetic wavelengths are reflected from different surfaces. The ultrasound is reflected with sufficient intensity from surface of water and from surface of runway (solid). However, ultrasound reflection from vegetation is very weak. Furthermore, the electromagnetic wavelength in the whole infrared range is reflected with sufficient intensity from runway (solid ground) or from vegetation. However, the reflection in infrared wavelengths is weak from water.

The comparison between reflections of ultrasound and electromagnetic wavelengths from the reflecting surfaces is presented in table 1.

According to an example of an embodiment of the invention, when aircraft, preferably amphibian, is about to land, and in this case to the water, the reflection of the ultrasound wavelength is strong and the reflection of electromagnetic wavelength is weak, because of stronger absorption in water for electromagnetic wavelength. Thereby landing surface is determined to be water based on the intensities of the reflections.

According to an example of an embodiment of the invention, when aircraft, preferably amphibian, is about to land, and in this case to runway (=ground) the reflection of the ultrasound wavelength is strong and the reflection of electromagnetic wavelength is also strong. Thereby landing surface can be determined to be runway based on the strong intensities of the both reflections.

According to an example of an embodiment of the invention, when aircraft, preferably amphibian, is about to land, and in this case to runway having vegetation near disturbing altitude determination, the reflection of the ultrasound is weak and the reflection of the electromagnetic wavelength is strong, as listed in Table 1. When vegetation is detected by weak ultrasound intensity and strong IR intensity, the arrangement determines the correct altitude and based on measured distance property of electromagnetic wavelength.

TABLE 1
Reflection intensities of ultrasound and electromagnetic
wavelengths from different surfaces.

| Surface | Electromagnetic (IR) | Ultrasound |
|---|---|---|
| Water | − (weak) | + (strong) |
| Runway | + (strong) | + (strong) |
| Vegetation | + (strong) | − (weak) |

An example of an embodiment of the present invention is that the safety arrangement comprises detecting means for detecting position of a landing gear.

An example of an embodiment of the present invention is that the safety arrangement comprises determining means for determining if landing gear is in correct or incorrect position which corresponds the type of landing surface.

An example of an embodiment of the present invention is that the safety arrangement comprises controller for outputting signal, such as sound, light, and/or tactile/vibration effect, indicates the type of the determined landing surface, preferably also whether the landing gear is in correct or incorrect position corresponding the type of the landing surface based on the determined type of the landing surface and the position of the landing gear.

An example of an embodiment of the present invention is that the safety arrangement comprises detecting means for detecting that landing is iniated based on by detecting a predetermined value of at least one of the following: flaps in landing position, engine power level typical for landing, altitude, descending speed (or variometer) typical for landing, and/or velocity.

An example of an embodiment of the present invention is that the first transceiver operates on electromagnetic wavelength in the range 400-2200 nm, preferably in the range 400-700 nm.

An example of an embodiment of the present invention is that the first transceiver is laser distance measuring system.

Preferably the second transceiver in the embodiments of the invention is distance measuring device operating on ultrasound wavelengths.

An example of an embodiment of the present invention is that the safety arrangement comprises third transceiver configured to operate on wavelength 380-500 nm. The use of this wavelength range can be utilized for determining the presence of vegetation near the landing area and/or eliminating the effect of vegetation on first two wavelengths when determining the type of landing surface. The vegetation can include any vegetation including trees, bushes, plants, grass among other things. From FIG. 2 can be seen that reflection for vegetation between wavelengths 380-500 nm is stronger than for other landing surface types. When vegetation is detected, the arrangement determines the correct altitude and based on measured distance property of electromagnetic wavelength of first transceiver, and signals that landing surface type is ground.

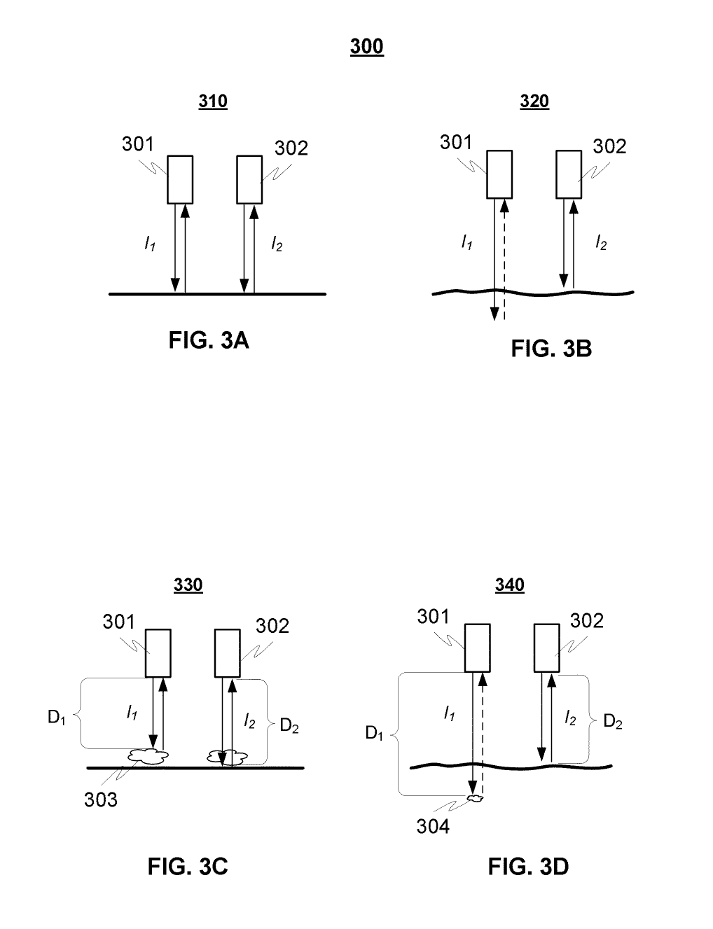

FIGS. 3A-3D illustrate a principle of an exemplary arrangement 300 and method 310, 320 based on the intensity measurements and method based on the distance measurements 330, 340 for determining a surface type according to an advantageous embodiment of the invention, wherein the arrangement comprises a first transceiver 301 operated on electromagnetic wavelength and a second transceiver 302 operated on ultrasound wavelength, as discussed elsewhere in this document.

In the example 310 the surface type is a hard ground, such as a tarmac runway, and the both wavelengths are reflected from the surface of the ground. The reflections of both wavelengths, I1 and I2, are strong, the surface is determined to be hard ground.

In the example 320 the surface type is water, whereupon the electromagnetic wavelength is essentially not reflected at all (is absorbed) or only minor portion of it is reflected (this is the case for example if the first wavelength is in the near infrared area), whereas the ultrasound wavelength is again reflected from the surface of the water. Now in the case of water the intensity I1 of the reflection (if any) of the first wavelength is negligible in relation to the intensity I2 of the reflection of the second wavelength.

Thus the surface type (hard ground or water) can be determined based on the mutual intensity differences of said electromagnetic and ultrasound reflected wavelengths so that if the intensities I1 and I2 of the reflections are both strong, the type of the landing surface is determined to be as hard ground, and vice versa, if the intensity I1 of the reflection of the first wavelength is weak and the intensity I2 of the reflection of the second wavelength is strong, the type of the landing surface is determined to be as water.

In the example 330 the surface type is a hard ground, such as a tarmac runway, and in addition there is also vegetation 303 in the landing area or in the final of the runway (extension of the runway), such as grass, bush or trees. In this case, when the electromagnetic wavelengths is selected properly, the electromagnetic wavelength I1 will reflect already on the top portion of the vegetation, whereupon the ultrasound wavelength I2 will not be reflected from the vegetation or will reflect from the hard ground, and the intensity or distances measured via said reflections differs from each other.

In the example 340 the surface type is water, whereupon the electromagnetic wavelength I1 is essentially not reflected at all (is absorbed) from the surface of the water, but it is reflected from the particles 304 inside the water or even from the bottom of the water, whereas the ultrasound wavelength I2 is again reflected from the surface of the water, whereupon the distances measured via said reflections differs again from each other but in opposite direction than in the case of hard ground.

In the examples of 330, 340 the distances D1 and D2 of the reflected wavelengths are measured, and based on the distance difference the surface type can be determined so that if the distance D1 measured via the reflection of the electromagnetic wavelength is shorter than the distance D2 measured via the reflection of the ultrasound wavelength, the type of the landing surface is determined to be as hard ground, and vice versa, if the distance D1 measured via the reflection of the electromagnetic wavelength is longer than the distance D2 measured via the reflection of the second ultrasound wavelength, the type of the landing surface is determined to be as water.

An example of an embodiment of the present invention is that the safety arrangement determines the surface type by comparing the distance measurements between the said two wavelengths.

An example of an embodiment of the present invention is that the arrangement determines the surface type based on the absorption of the two wavelengths by the reflecting surface, or based on intensities of the reflections.

An example of an embodiment of the present invention is that the method comprises a step of determining the surface type by comparing the distance measurements between the said two different wavelengths and/or by comparing the absorption between the two different wavelengths by the reflecting surface (reflection intensities).

Next more detailed examples of the operation of the present invention:

1) An amphibious airplane is flying and about to land on a runway of an airport. The safety arrangement is operating during flight, and first and second transceivers are transmitting on electromagnetic and ultrasound wavelengths respectively towards landing surface (=runway). Transceivers are configured to receive the reflections on said transmitted wavelengths. The safety arrangement then determines with determining means, based on the strong intensity of reflections of both wavelengths, that landing surface is solid ground and outputs a signal that indicates that landing surface is solid ground. The safety arrangement also detects that the landing gear is extended (out) which is correct position for landing in this case. The controller of the safety arrangement outputs a signal that indicates that the landing gear is in correct position.

2) As explained in example 1) above, but the safety arrangement detects that the landing gear is retracted (inside), and that is incorrect position for landing on the runway. The controller of the safety arrangement outputs a signal that indicates that the landing gear is in incorrect position.

3) An amphibious airplane is flying and is about to land on a water. The safety arrangement is operating during flight, and first and second transceivers are transmitting on electromagnetic and ultrasound wavelengths respectively towards landing surface (=water). Transceivers, are configured to receive the reflections on said transmitted wavelengths. The safety arrangement then determines with determining means, based on strong intensity of reflection of ultrasound and weak intensity reflection of IR wavelength, that landing surface is water and outputs a signal that indicates that landing surface is water. The safety arrangement also detects that the landing gear is retracted (inside) which is correct position for landing in this case. The controller of the safety arrangement outputs a signal that indicates that the landing gear is in correct position.

4) As explained in example 3) but the safety arrangement detects that the landing gear is extended (out), and that is incorrect position for landing on water. The controller of the safety arrangement outputs a signal that indicates that the landing gear is in incorrect position.

In all above examples of an embodiment of the present invention, the arrangement can determine the surface type based on measured distance of the wavelength instead of intensity, so that distance is determined with wavelength for which reflection is received or for which the intensity is relatively stronger.

The invention has been explained above with reference to the aforementioned embodiments, and several advantages of the invention have been demonstrated. It is clear that the invention is not only restricted to these embodiments, but comprises all possible embodiments within the spirit and scope of the inventive thought and the following patent claims.

1. A safety arrangement (300, 310, 320, 330, 340) for an aircraft, especially for amphibious aircraft, said safety arrangement being configured for determining a type of a landing surface, characterized in that the arrangement comprises:
a first transceiver (301) configured to operate on electromagnetic wavelength, where said transceiver is configured to transmit said electromagnetic wavelengths essentially towards said landing surface and to receive the reflections of said electromagnetic wavelengths,
a second transceiver (302) configured to operate on ultrasound wavelengths, where second transceiver (302) is configured to transmit said ultrasound wavelengths essentially towards said landing surface and to receive the reflections of said ultrasound wavelengths,
determining means for determining the type of the landing surface based on the properties of reflections of said electromagnetic and ultrasound wavelengths, and for outputting a signal indicating the type of the determined landing surface.

2. A safety arrangement according to claim 1, wherein the safety arrangement comprises detecting means for detecting position of a landing gear and determining means for determining if landing gear is in correct or incorrect position corresponding the type of landing surface.

3. A safety arrangement according to claim 1, wherein the safety arrangement comprises controller for outputting signal, such as sound, light, and/or tactile/vibration effect, indicating the type of the determined landing surface and/or whether the landing gear is in correct or incorrect position corresponding the type of the landing surface based on the determined type of the landing surface and the position of the landing gear.

4. A safety arrangement according to claim 1, wherein the safety arrangement comprises detecting means for detecting that landing is initiated based on by detecting a predetermined value of at least one of the following: flaps in landing position, engine power level typical for landing, descending speed (variometer) typical for landing, altitude, and/or velocity typical for landing.

5. A safety arrangement according to claim 1, wherein the ultrasound transceiver is comprised in ultrasound distance measuring system.

6. A safety arrangement according to claim 1, wherein the first transceiver (301) operates on electromagnetic wavelength in the range 400-2200 nm, preferably in the range 400-700 nm.

7. A safety arrangement according to claim 1, wherein the safety arrangement comprises third transceiver configured to operate on wavelength 380-500 nm.

8. A safety arrangement according to claim 1, wherein the arrangement determines the surface type by comparing the distance measurements between the said two different wavelengths.

9. A safety arrangement according to claim 1, wherein the arrangement determines the surface type based on the absorption of the two different wavelengths by the reflecting surface by comparing the intensities of the reflected wavelengths.

10. Method for determining a type of the landing surface for an aircraft, characterized in that the method comprises the following steps:
transmitting in an electromagnetic wavelength and in an ultrasound wavelength essentially towards said landing surface,
receiving the reflections of said electromagnetic and ultrasound wavelengths
determining the properties of said two wavelengths reflected from said landing surface,
determining the type of the landing surface based on the properties of said two wavelengths reflected from said landing surface.

11. A method according to claim 10, wherein the position of a landing gear is detected and determined whether the landing gear is in correct or incorrect position corresponding the type of landing surface and outputting a signal is outputted, such as sound, light, and/or tactile/vibration effect, indicating whether the landing gear is in correct or incorrect position corresponding the type of the landing surface based on the determined type of the landing surface and the position of the landing gear.

12. A method according to claim 10, wherein the surface type is determined by comparing the distance measurements between the said two different wavelengths and/or the surface type is determined based on the intensity comparison between the reflections of wavelengths.

13. An aircraft, such as an amphibious aircraft, characterized in that it comprises the safety arrangement (300, 310, 320, 330, 340) according to claim 1.

14. A computer program product for determining a type of the landing surface for an aircraft, characterized in that it comprises program code means stored on a computer-readable medium, which code means are arranged to perform the steps of the method defined in claim 10, when the program is run on a computer.

15. A safety arrangement according to claim 2, wherein the safety arrangement comprises controller for outputting signal, such as sound, light, and/or tactile/vibration effect, indicating the type of the determined landing surface and/or whether the landing gear is in correct or incorrect position corresponding the type of the landing surface based on the determined type of the landing surface and the position of the landing gear.

16. A method according to claim 11, wherein the surface type is determined by comparing the distance measurements between the said two different wavelengths and/or the surface type is determined based on the intensity comparison between the reflections of wavelengths.
